(19) United States
(12) Patent Application Publication
(10) Pub. No.: US 2005/0051216 A1
(43) Pub. Date: Mar. 10, 2005

(54) Pressure opening and closing valve

(76) Inventor: Hiroji Sato, Tokyo (JP)

Correspondence Address: HAUPTMAN KANESAKA BERNER PATENT AGENTS, SUITE 300, 1700 DIAGONAL RD, ALEXANDRIA, VA, 22314-2848, US

(21) Appl. No.: 10/923,883

(22) Filed: Aug. 24, 2004

(30) Foreign Application Priority Data
Sep. 4, 2003 (JP) 2003-312477

(51) Int. Cl. F16K 17/26

(52) U.S. Cl. 137/493.6

(57) ABSTRACT

A pressure opening and closing valve includes a housing having a first port and a second port; a valve member disposed in the housing for closing the first port in a normal state and opening the first port when a differential pressure between the first port and the second port exceeds a predetermined value; and a spring for urging the valve member. The spring applies an urging force to the valve member in a direction unparallel to an axial line of a valve seat against which the valve member abuts.

### BACKGROUND OF THE INVENTION AND RELATED ART STATEMENT

The present invention relates to a pressure opening and closing valve provided in a middle of a conduit for automatically opening and closing according to a differential pressure at a front side and a rear side of the pressure opening and closing valve. More specifically, the present invention relates to a pressure opening and closing valve suitable for a two-way valve to be disposed between a fuel tank of an automobile and a canister for maintaining a pressure in the fuel tank within a predetermined range.

A pressure opening and closing valve with a two-way blocking function is provided between a fuel tank of an automobile and a canister for maintaining a pressure in the fuel tank within a predetermined range. When fuel is filled in the fuel tank, the pressure opening and closing valve is closed in two ways for detecting a filling-up through an increase in the pressure in the tank. When the pressure in the tank exceeds a predetermined value due to an increase in a temperature, the pressure opening and closing valve is opened in a direction that the canister absorbs evaporation gas above a fuel surface. When the pressure in the tank becomes below the atmospheric pressure, the pressure opening and closing valve is opened in a direction that the atmospheric pressure enters from the canister.

Heretofore, there has been known a conventional pressure opening and closing valve in which a negative pressure valve member is disposed in a positive pressure valve member. The negative pressure valve member is opened when a tank becomes a negative pressure state. The positive pressure valve member is opened when the tank becomes a positive pressure state (refer to Japanese Patent Publication (Kokai) No. 09-60744).

In the conventional pressure opening and closing valve, when the inner pressure of the tank is positive and fuel gas flows between an inner peripheral surface of a housing retaining the positive pressure valve member therein and an outer peripheral surface of the positive pressure valve member, a turbulent flow is generated. As a result, the positive pressure valve member vibrates and collides with the inner peripheral surface of the housing, thereby generating noise. Also, the positive pressure valve member bounces in the housing due to vibration of a car body, thereby generating noise.

In order to prevent the noise, a space between the positive pressure valve member and the housing may be made small, so that the positive pressure valve member moves smoothly. However, it is difficult to make the space small enough to prevent the noise. In other words, in the conventional pressure opening and closing valve, it is difficult to prevent the noise and obtain the smooth operation thereof.

In view of the problems described above, an object of the present invention is to provide a pressure opening and closing valve capable of suppressing noise and operating smoothly.

Further objects and advantages of the invention will be apparent from the following description of the invention.

### SUMMARY OF THE INVENTION

In order to attain the objects described above, according to a first aspect of the present invention, a pressure opening and closing valve includes a housing having a first port and a second port; a valve member disposed in the housing for closing the first port in a normal state and opening the first port when a differential pressure between the first port and the second port exceeds a predetermined value; and a spring for urging the valve member. The spring applies an urging force to the valve member in a direction not in parallel to an axial line of a valve seat against which the valve member abuts.

According to a second aspect of the present invention, a pressure opening and closing valve is disposed in a path connecting a space above a liquid surface in a fuel tank and a canister. The pressure opening and closing valve includes a housing having a fist port and a second port; a positive pressure valve member disposed in the housing for closing the first port against a positive pressure in the fuel tank and opening the first port at a predetermined positive pressure; a spring for urging the positive pressure valve member; a negative pressure valve member for closing against a negative pressure in the fuel tank and opening at a predetermined negative pressure value; and a second spring for urging the negative pressure valve member. The first spring applies an urging force to the positive pressure valve member in a direction not in parallel to an axial line of a valve seat against which the positive pressure valve member abuts.

According to a third aspect of the present invention, in the pressure opening and closing valve described above, the spring is formed of a coil spring. A spring seat crossing a central axis of the valve seat at an angle other than the right angle is provided in the housing. The coil spring is attached to the spring seat so that an axial line of the coil spring in a natural state is not in parallel to the axis line of the valve seat.

According to a fourth aspect of the present invention, the spring may be a coil spring wound with both ends having offset centers.

In the pressure opening and closing valve of the present invention described above, an axial line of a valve closing force acting on the valve member is inclined with respect to a central axis of the housing. As a result, the valve member contacts an inner surface of the housing. Accordingly, even if a space between the housing and the valve member is large, the valve member does not bounce in the housing, thereby preventing noise. In other words, it is possible to prevent the noise and obtain smooth operation.

### BRIEF DESCRIPTION OF THE DRAWINGS

FIG. 1 is a partially sectional exploded view showing a pressure opening and closing valve according to an embodiment of the present invention;

FIG. 2 is a sectional view showing the pressure opening and closing valve in a state that the valve is closed;

FIG. 3 is a sectional view showing the pressure opening and closing valve in a state that a positive pressure valve member is opened;

FIG. 4 is a sectional view showing the pressure opening and closing valve in a state that a negative pressure valve member is opened; and

FIG. 5 is a view showing a modified example of a coil spring.

### DETAILED DESCRIPTION OF PREFERRED EMBODIMENTS

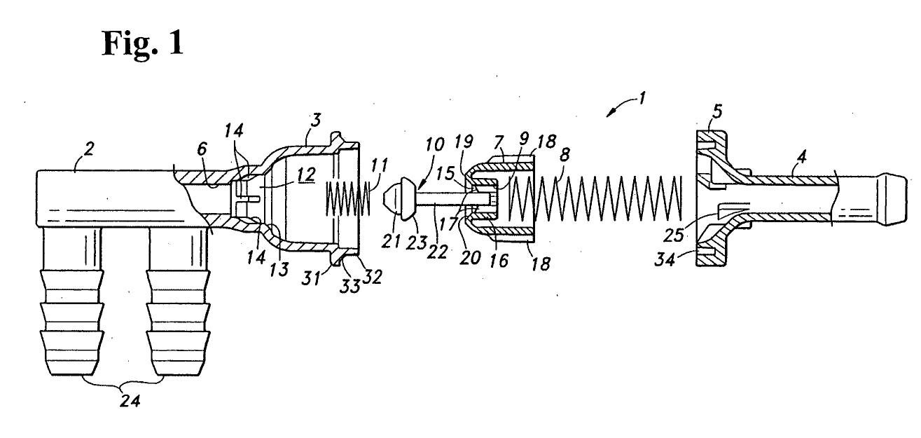

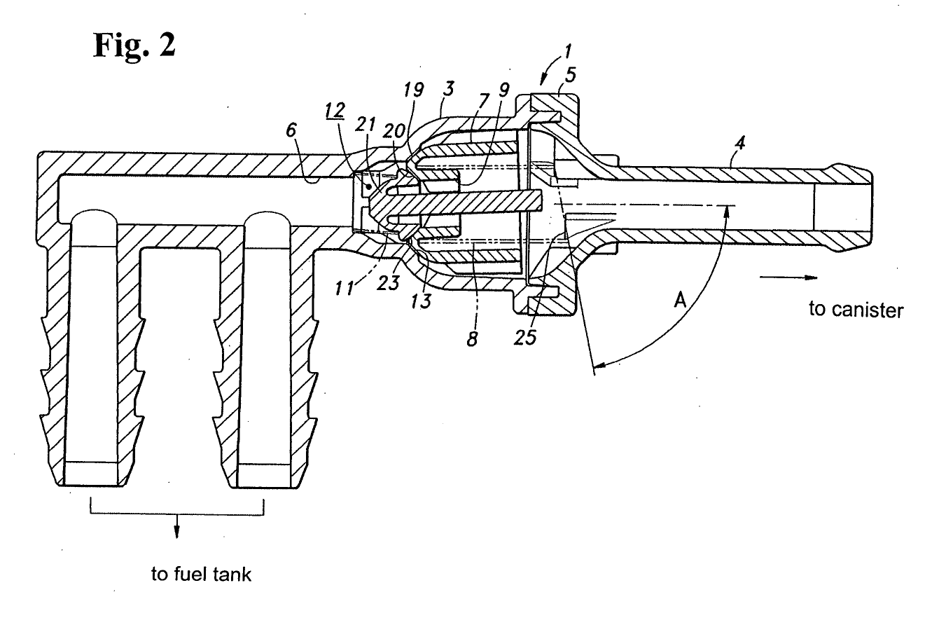

Hereunder, embodiments of the invention will be explained with reference to the accompanying drawings. FIGS. 1 and 2 are views showing a pressure opening and closing valve as a two-way valve according to an embodiment of the present invention. A pressure opening and closing valve 1 includes a housing main portion 3 integrated with a hose connecting member 2; a housing cap 5 integrated with a hose connecting port 4, or a second port; a positive pressure valve member 7 for opening and closing a communication path between a fluid path 6, or a first port, formed in the hose connecting member 2 and the housing main portion 3; a large diameter coil spring 8 for urging the positive pressure valve member 7 to close the same; a negative pressure valve member 10 for opening and closing a negative pressure path 9 formed at a central portion of the positive pressure valve member 7; and a small diameter coil spring 11 for urging the negative pressure valve member 10 to close the same.

The housing main portion 3 has substantially a bowl shape with an opening on a side opposite to the hose connecting member 2. The housing main portion 3 is provided with a negative pressure valve member receiving portion 12 having a diameter slightly larger than an inner diameter of the fluid path 6 on an inner side of a base portion of the hose connecting member 2, i.e. an opening portion of the fluid path 6 connected to the housing main portion 3. A positive pressure valve seat 13 with a circular cone surface extending outwardly toward the housing main portion 3 is formed around an opening of the negative pressure valve member receiving portion 12 toward the housing main portion 3. A plurality of projections 14 extending along an axial direction is disposed on an inner surface of the hose connecting member 2 at positions equally dividing a circumference for supporting the small diameter coil spring 11.

The housing cap 5 has substantially a disc shape with a center connected to the hose connecting port 4, and is fixed to an opening end of the housing main portion 3 by, for example, ultrasonic welding.

The positive pressure valve member 7 has a cylindrical shape with a bottom, and is provided with a through-hole 15 at a central portion of the bottom thereof. A tubular portion 16 is formed along an axial direction toward the positive pressure valve member 7 for defining a negative pressure path 9 connected to the through-hole 15. Projections 17 are formed on an inner peripheral surface of the tubular portion 16 along the axial direction at positions equally dividing a circumference. The positive pressure valve member 7 is also provided with four projections 18 extending along the axial direction on an outer peripheral surface thereof at positions equally dividing the circumference; an annular swelling portion 19 having an annular outer surface on the outer bottom surface thereof at an outer periphery of the through-through 15; and a negative pressure valve seat 20 having a circular cone surface extending toward the negative pressure valve member receiving portion 12 on an inner periphery of the through-hole 15, i.e. an opening portion of the negative pressure path 9.

The positive pressure valve member 7 is disposed in the housing main portion 3 with the annular swelling portion 19 facing the positive pressure valve seat 13 formed in the housing main portion 3. The large diameter coil spring 8 is provided between the bottom surface of the positive pressure valve member 7 and the inner surface of the housing cap 5 in the axial direction, and constantly urges the positive pressure valve member 7 in a direction that the annular swelling portion 19 abuts against the positive pressure valve seat 13. The annular swelling portion 19 contacts or separates from the positive pressure valve seat 13 for functioning as a two-way valve.

The negative pressure valve member 10 is integrally formed of a valve head portion 21 and a shaft portion 22. The shaft portion 22 is inserted into the four projections 17 on the inner surface of the tubular portion 16, so that the negative pressure valve member 10 engages the positive pressure valve member 7 to be movable in the axial direction. A spherical zone portion 23 is formed on an outer surface of the valve head portion 21 on a side of the shaft portion 22. The negative pressure valve member 10 is constantly urged by the small diameter coil spring 11 supported at a base end of the negative pressure valve member receiving portion 12 in a direction that the spherical zone portion 23 abuts against the negative pressure valve seat 20. The spherical zone portion 23 contacts or separates from the negative pressure valve seat 20 for functioning as a two-way valve.

The hose connecting member 2 is provided with two hose ports 24 to be connected to exits of a floating valve (not shown) provided in a space above a liquid level of a fuel tank of an automobile through rubber hoses. Incidentally, a direction and the number of the hose ports 24 are suitably determined according to a type of fuel tank, and not limited thereto. It is preferred that the respective parts are made of a synthetic resin with injection molding. Especially, it is preferable to use a polyacetal resin with excellent gasoline permeability.

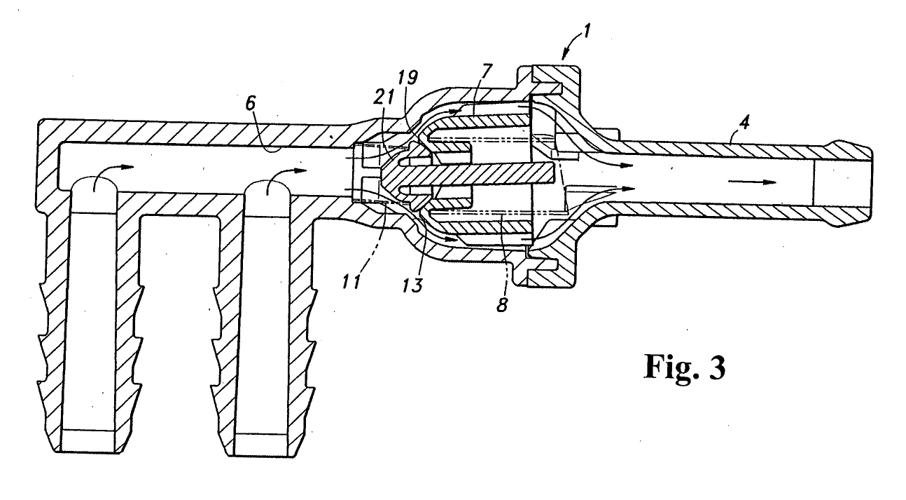

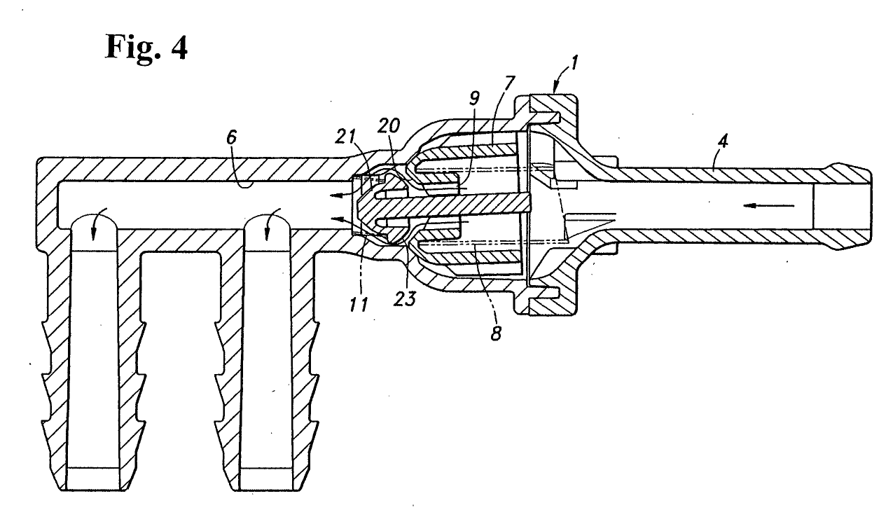

An operation of the pressure opening and closing valve will be explained next with reference to FIGS. 3 and 4. As shown in FIG. 2, in a normal state of the pressure opening and closing valve 1, pressures in the flow path 6 (first port) and the hose connecting port 4 (second port) are substantially equal. In other words, the spherical zone portion 23 of the valve head portion 21 is pressed against the negative pressure valve seat 20 on the positive pressure valve member 7 with the urging force of the small diameter coil spring 11. The annular swelling portion 19 of the positive pressure valve member 7 is pressed against the positive pressure valve seat 13 at the opening of the negative pressure valve member receiving portion 12 with the urging force of the large diameter coil spring 8. Accordingly, the communication between the flow path 6 and the hose connecting port 4 is closed.

From the above-described state, when an inner pressure of the fuel tank increases so that a differential pressure between the fluid path 6 and the hose connecting port 4 exceeds a predetermined value, the positive pressure valve member 7 is opened and moved against the urging force of the large diameter coil spring 8 by the positive pressure from the fluid path 6 as shown in FIG. 3. The annular swelling portion 19 of the positive pressure valve member 7 is separated from the positive pressure valve seat 13, so that the fluid path 6 communicates with the hose connecting port 4. At this time, the negative pressure valve member 10 moves together with the positive pressure valve member 7 by the urging force of the small diameter coil spring 11 while maintaining a state that the negative pressure valve member 10 engages the positive pressure valve member 7. Accordingly, evaporation gas in the fuel tank flows toward the canister through the pressure opening and closing valve 1, thereby releasing the pressure in the fuel tank to the atmosphere.

On the other hand, when the pressure in the fuel tank decreases and the pressure on a side of the hose connecting port 4 becomes higher than that on a side of the fluid path 6, the negative pressure valve member 10 is opened against the urging force of the small diameter coil spring 11 by the negative pressure of the fluid path 6 as shown in FIG. 4. The negative pressure valve member 10 is separated from the negative pressure valve seat 20 on the positive pressure valve member 7, so that the negative pressure path 9 of the center portion of the positive pressure valve member 7 is opened. At this time, the positive pressure valve member 7 is held in a state abutting against the positive pressure valve seat 20 since the direction of the urging force of the large diameter coil spring 8 is same as that of a pressure slope. Therefore, evaporation gas flows into the fuel tank from the canister by the positive pressure on a side of the canister through the pressure opening and closing valve 1, thereby releasing the pressure in the fuel tank to the atmosphere. Accordingly, the pressure opening and closing valve 1 operates as the two-way valve to maintain the pressure in the fuel tank within a predetermined range.

In the pressure opening and closing valve 1 described above, a spring supporting portion 25, or a spring seat, is provided on the housing cap 5, and abuts against an end of the large diameter coil spring 8 at an abutting surface thereof inclined with a specific angle A, not a right angle, relative to the central axis of the housing main portion 3. In the normal state, the central axis of the large diameter coil spring 8 is not parallel to the central axis of the housing main portion 3, i.e. the central axis of the large diameter coil spring 8 is inclined with the specific angle relative to the axis line of the positive pressure valve seat 13 formed on the central portion of the housing main portion 3.

When the positive pressure valve member 7 is installed in the housing main portion 3 while compressing the large diameter coil spring 8, an urging direction of the large diameter coil spring 8 is not in parallel to the axis line of the positive pressure valve seat 13. In other words, when an outer peripheral surface of the annular swelling portion 19 of the positive pressure valve member 7 is pressed against the positive pressure valve seat 13, since the urging direction is inclined, the positive pressure valve member 7 is inclined. Accordingly, a space between the projections 18 provided on the outer peripheral surface of the positive pressure valve member 7 and the inner peripheral surface of the housing main portion 3 becomes uneven, so that the positive pressure valve member 7 contacts the inner peripheral surface of the housing main portion 3 at one side thereof. With this structure, it is possible to prevent the positive pressure valve member 7 from bouncing in the housing main portion 3, thereby eliminating noise due to a turbulent flow of gas or a vibration of a car body.

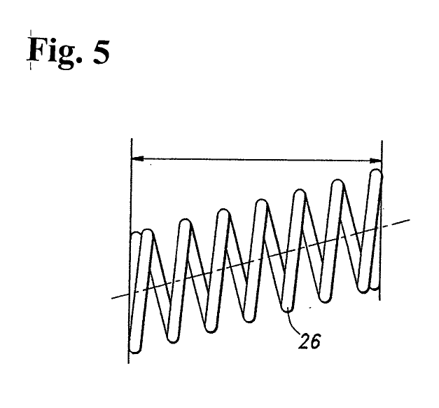

FIG. 5 shows another method for inclining the axis line of the urging force with respect to the positive pressure valve member 7. In this method, a large diameter coil spring 2.6 is wound so that an axis line thereof is inclined in a natural state. In the embodiment, a center of the positive pressure valve seat 13 is aligned with a center of the spring supporting portion 25, and the spring supporting portion 25 is arranged such that an abutting surface thereof against the end of the large diameter coil spring 26 crosses in a state perpendicular to the central axis of the housing main portion 3. When the large diameter coil spring 26 is compressed and installed between the positive pressure valve member 7 and the spring supporting portion 25, the center of the large diameter coil spring 26 with respect to the positive pressure valve member 7 is shifted from the center of the positive pressure valve seat 13, so that the same effect as that of the embodiment described above can be obtained.

As another method of inclining the axis line of the urging force with respect to the positive pressure valve member 7, the center of the supporting portion 25 of the large diameter coil spring 8 may be shifted from the center of the positive pressure valve seat 13 in a radial direction. However, when the center of the supporting portion 25 of the large diameter coil spring 8 is shifted so that the positive pressure valve member 7 contacts the inner peripheral surface of the housing main portion 3, a diameter of the housing becomes large. Therefore, it is preferable to employ the structure described above, thereby making the housing small.

An inner peripheral contour of a connecting portion between the hose connecting member 2 and the housing main portion 3, and an outer peripheral contour of the positive pressure valve member 7 facing the inner peripheral contour have arched curve surfaces, respectively, so that a curvature of the fluid path becomes smooth. With this structure, when the positive pressure on the side of the fuel tank is released to the side of the canister, gas flows smoothly without a turbulent flow along the periphery of the positive pressure valve member 7 where gas tends to flow strongly, thereby preventing the positive pressure valve member 7 from shaking.

The housing main portion 3 is welded to the housing cap 5. An outward flange 31 is provided on the peripheral wall of the housing main portion 3 at a position slightly retreated from an opening edge thereof. A fillet portion 33 is formed at a connecting portion between the flange 31 and an opening edge portion 32 of the peripheral wall of the housing main portion 3. An annular groove 34 to be fitted to the opening edge portion 32 of the housing main portion 3 is provided on a connecting surface of the housing cap 5 connected to the housing main portion 3. An edge is formed at an opening edge of the annular groove 34.

In a state that the opening edge portion 32 of the housing main portion 3 is fitted to the annular groove 34 of the housing cap 5, when the housing main portion 3 is attached to the housing cap 5 with an ultrasonic welding, the fillet portion 33 is molten to fuse the housing main portion 3 and the housing cap 5 together. At this time, the housing main portion 3 is welded to the housing cap 5 at an outer peripheral side of the opening edge portion 32. Accordingly, even if an excess molten resin flows out, the molten resin does not flow in the opening edge portion 32, thereby eliminating an influence of the weld flash on the valve operation. Also, as compared with a conventional fitting connection, the opening edge portion 32 on the peripheral wall of the housing main portion 3 is fitted in the annular groove 34 of the housing cap 5, thereby obtaining strong connection.

Hereinabove, the present invention has been applied to the two-way valve, and can be applied to a one-way valve without the negative pressure valve member.

The pressure opening and closing valve according to the invention can be used as an automatic pressure controlling valve for automatically opening and closing the valve according to a pressure in various containers or other closed spaces to maintain the pressure in the various containers or the other closed spaces within a predetermined range.

The disclosure of Japanese Patent Application No. 2003-312477 filed on Sep. 4, 2003, is incorporated in the application.

While the invention has been explained with reference to the specific embodiments of the invention, the explanation is illustrative and the invention is limited only by the appended claims.

1. A pressure opening and closing valve comprising:
a housing having a first port and a second port,
a first valve member disposed in the housing for generally closing the first port and opening the first port when a differential pressure between the first port and the second port exceeds a predetermined value,
a valve seat disposed in the housing adjacent to the first port for receiving the valve member to close the first port, and
a first spring disposed in the housing for urging the first valve member toward the valve seat, said first spring having a spring axial line eccentric to a valve axial line of the valve seat.

2. A pressure opening and closing valve according to claim 1, wherein said first valve member is arranged so that the first valve member opens the first port when a pressure at the first port exceeds a predetermined level.

3. A pressure opening and closing valve according to claim 2, further comprising a second valve member disposed in the housing for opening the first port when a pressure at the first port becomes below a predetermined level, and a second spring for urging the second valve member to close the same.

4. A pressure opening and closing valve according to claim 3, wherein said second valve member is attached to the first valve member to move relative thereto.

5. A pressure opening and closing valve according to claim 4, wherein said first valve member is arranged such that an outer surface of the first valve member contacts an inner surface of the housing.

6. A pressure opening and closing valve according to claim 1, wherein said first spring is formed of a coil spring.

7. A pressure opening and closing valve according to claim 6, further comprising a spring seat provided in the housing for receiving the first spring, said spring seat being arranged to cross the valve axial line with an angle other than a right angle so that the spring axial line of the first spring extends in a natural state eccentrically relative to the valve axial line.

8. A pressure opening and closing valve according to claim 6, wherein said first spring has two end portions with centers offset with each other.
